(19) United States
(12) Patent Application Publication
(10) Pub. No.: US 2005/0227619 A1
(43) Pub. Date: Oct. 13, 2005

(54) Broadband wireless repeater for mobile communication system

(76) Inventors: Jong Hwan Lee, Kyonggi-do (KR); Chon Won Kim, Kyonggi-do (KR); Chang wook Lee, Kyonggi-do (KR); Hyung Gun Kim, Kyonggi-do (KR)

Correspondence Address: SHERIDAN ROSS PC, 1560 BROADWAY, SUITE 1200, DENVER, CO, 80202, US

(21) Appl. No.: 10/343,409

(22) PCT Filed: Sep. 17, 2002
(86) PCT No.: PCT/KR02/01732

§ 371 Date: Jan. 28, 2003

(30) Foreign Application Priority Data
Feb. 21, 2002 (KR) 2002-9334

(51) Int. Cl. H04B 7/14

(52) U.S. Cl. 455/22; 455/11.1; 455/23

(57) ABSTRACT

Disclosed herewith is a broadband wireless repeater for a mobile communication system. The broadband wireless repeater generally includes a transmission stage and a receiving stage. The transmission stage includes an RF switch for establishing a frequency path, an Intermediate Frequency delay unit for applying delay to IFs and bypassing the IF delay, a frequency up conversion modulator, an amplifier, a filter unit for eliminating undesired band signals, and a transmitting side antenna. The receiving stage includes an array antenna, a band-pass filter unit for eliminating undesired band signals, an amplifier, a phase shifter for controlling phases of channels, a frequency down conversion modulator, a phase comparison unit, a gain comparison unit, a vector value optimizer for decreasing errors of the main signals with a maximum output, and a synthesizing module for detecting and storing output levels of the channels.

### BACKGROUND OF THE INVENTION

1. Field of the Invention

The present invention relates generally to a broadband wireless repeater for a mobile communication system, and more particularly to a broadband wireless repeater used to repeat wirelessly received signals at the same frequencies in a mobile communication system, to which interference signal cancellation technology is applied so as to prevent Radio Frequency oscillation.

2. Description of the Related Art

The conventional mobile communication system is problematic in that its coverage area is limited because a desired amount of power cannot be outputted due to difficulty in ensuring the sufficient isolation of a transmitting antenna from a receiving antenna, and a shadow area, which is a region within a coverage area in which effective radio frequency receiving of signals is improbable, is formed. In order to extend the coverage area and eliminate the shadow area, mobile communication service provider adopt repeaters and repeater solutions. Early repeaters; mainly, Radio Frequency (RF) repeaters, were mostly used in subway station buildings and shadow areas in tunnels. Currently, a variety of repeaters, such as frequency conversion repeaters, digital optical repeaters, small-scale repeaters, etc. as well as analog optical repeaters are used in a variety of locations, so an enormous demand for the repeaters is anticipated.

In particular, an RF repeater cannot cover a desired area because its output power is limited due to a problem of isolating antennas from each other(transmitting & receiving antennas) Such a repeater is positioned between a base station and a mobile stations, and receives a low-level signal from the base station, amplifies the signal to have the same high level as a signal in the base station and retransmits the amplified signal to the mobile stations, thus providing an excellent communication quality. The repeater carries out functions of receiving and amplifying a signal having low power and retransmitting the amplified signal, and requires separate transmitting and receiving antennas to carry out the functions.

In the meantime, interference signals fed back to the receiving antenna from the transmitting antenna are eliminated by spatial signal processing technology used in the field of smart antennas, so the repeater can be stably operated and a distance between transmitting and receiving antennas can be considerably reduced, thereby being convenient for the installation and operation of the repeater.

However, the conventional repeater is problematic in that an amplified signal transmitted from the transmitting antenna is re-received by the receiving antenna and re-amplified by the repeater, so the normal operation of the repeater is impaired by saturation, oscillation, devices fails or the like, thus resulting in the degradation(call fails) of a communication quality.

Additionally, the elimination of interference signals, which originate from transmitted signals, from signals received from a receiving antenna, should be accomplished by the repeater.

### SUMMARY OF THE INVENTION

Accordingly, the present invention has been made keeping in mind the above problems occurring in the prior art, and an object of the present invention is to provide a broadband wireless repeater for a mobile communication system, in which an interference signal cancellation circuit is formed in a repeater and the repeater is added to a repeating apparatus for a cellular network, a Personal Communication Service (PCS) network and an International Mobile Telecommunications-2000 (IMT-2000) network, or an interference signal cancellation circuit is configured to be operated in conjunction with another type of interference signal cancellation circuit, thus maximizing the cancellation performance.

Another object of the present invention is to provide a broadband wireless repeater for a mobile communication system, which is capable of being effectively used in a shadow area as well as an underground area and a building.

Another object of the present invention is to provide a broadband wireless repeater for a mobile communication system, which is capable of being effectively used in open and indoor areas for mobile communication networks, such as a cellular network, a PCS network and an IMT-2000 network.

In order to accomplish the above object, the present invention provides a broadband wireless repeater for a mobile communication system, which is capable of eliminating interference signals fed back from a transmitting antenna using phase and gain control techniques, thus being capable of performing a repeating service in shadow and urban areas.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing an overall structure of a broadband wireless repeater for a mobile communication system in accordance with the present invention, which is linked in a forward direction;

FIG. 2 is a flowchart showing an algorithm for measuring the receiving stage signals and interference signals of the broadband wireless repeater of the present invention;

FIG. 3 is a flowchart showing an algorithm for calculating the interference signals of the broadband wireless repeater of the present invention; and

FIG. 4 is a flowchart showing an algorithm that is applied to the normal operation of the broadband wireless repeater of the present invention.

### DETAILED DESCRIPTION OF THE EMBODIMENTS

Hereinafter, a structure and an operation of an embodiment of the present invention will be described in detail with respect to the accompanying drawings.

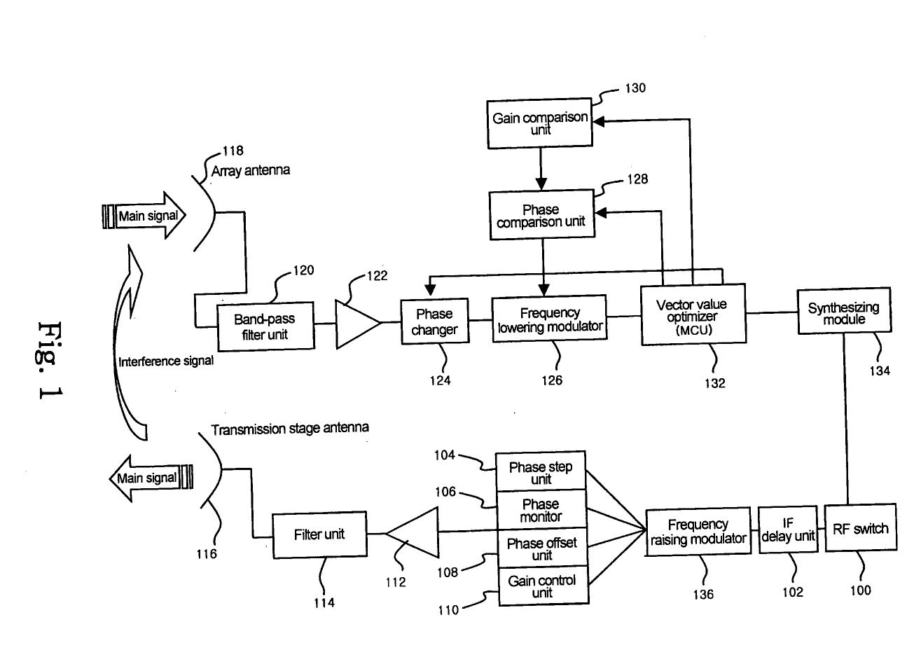

FIG. 1 is a block diagram showing an overall structure of a broadband wireless repeater for a mobile communication system in accordance with the present invention, which is linked in a forward direction.

The broadband wireless repeater of the present invention is generally comprised of a transmitting stage and a receiving stage.

Referring to FIG. 1, the transmission stage of the broadband wireless repeater is comprised of an RF switch 100 for turning on/off a frequency path for wireless repeating signals at the same frequencies; an Intermediate Frequency (IF) delay unit 102 for applying 10 μsec delay to IFs in the case of interference signal measurement, and bypassing the IF delay in the case where a service is being provided; a frequency up conversion modulator 136 for increasingly modulating the frequencies of a transmission path; a phase step unit 104 for changing the phases of the signals at regular periods to divide the signals into interference signals and main signals so as to be applied in an initial test mode and monitor the signals at regular periods; a phase monitor 106 for monitoring the main signals and the interference signals and determining whether the interference signals has been cancelled in terms of analog signals and digital signals by using a spectrum analyzer, and transmitting the results of the determination; a phase offset unit 108 for changing the phases of the signals to allow the vector value optimizer 132 to produce optimum vector values; a gain control unit 110 for compensating for gains changing depending upon the error rates of the main signals in the vector value optimizer 132; an amplifier (HPA) 112 for amplifying transmission signals; a filter unit 114 for eliminating undesired band signals from the transmission signals; and a transmitting side antenna 116 for receiving signals outputted from the amplifier 112, and transmitting the outputted signals to a shadow area or an urban area.

In such a case, the RF switch 100 is coupled to an input stage of the frequency up conversion modulator 136, while the phase step unit 104, the phase monitor 106, the phase offset unit 108 and the gain control unit 110 are coupled to an input stage of the amplifier 112 of the transmission stage.

The receiving stage of the broadband wireless repeater is comprised of an array antenna 118 for receiving signals transmitted from a base station and interference signals fed back from the transmitting antenna; a band-pass filter unit 120 for eliminating undesired band signals from signals received by the array antenna 118; an amplifier 122 for amplifying only original signals of the signals received by the array antenna 118 while suppressing the noise components of the signals, thus improving the sensitivity of the received signals; a phase shifter 124 for controlling the phases of the channels; a frequency down conversion modulator 126 for decreasingly modulating the frequencies of the received signals; a phase comparison unit 128 for controlling the amplitudes of the channels and comparing the phases of the channels with each other; a gain comparison unit 130 for detecting on the basis of channel No. 1 the phases of the modulated signals of the channels, and comparing gain differences with each other; a vector value optimizer 132 for selecting phase and amplitude values of one of the channels having a small error rate for its main signal by using the phase information of the phase comparison unit 128, or applying the phases and amplitudes of other channels, thus decreasing the errors of the main signals with a maximum output; a synthesizing module 134 for detecting and storing the output levels of the channels.

The vector value optimizer 132 employs a MOD 1 mode of decreasing the errors of the main signals with maximum outputs, and includes a gain and phase correcting means for setting the gains and phases of the receiving stage interference signals to be the same as a reference channel (Channel No. 1).

Alternatively, the vector value optimizer 132 can employ a MOD 2 mode of decreasing the errors of the main signals with maximum outputs, and includes a means for calculating the error rates of the main signals with soft data or applying expected error rates and performing fine control in a microprocessor.

Hereinafter, operations of component elements of the broadband wireless repeater of the present invention are described.

First, when a command to initialize the wireless repeater is inputted and transmitted, the transmission stage RF switch 100 blocks a path so as to measure receiving stage signals received from the antenna.

When main signals are received from the base station by the receiving stage antenna 118, the gain comparison unit 130 and the phase comparison unit 128 compare the gains and phases of channels, respectively, and the microprocessor stores data on the gains and the phases. The microprocessor performs a calculation to correct the phases and gains of the channels, and the synthesizing module 134 detects the output levels of the channels, and the microprocessor stores data on the output levels.

When the transmission stage RF switch 100 is turned on to establish a path, the gain comparison unit 130 compares the gains of the receiving stage interference signals of the channels, and the microprocessor stores data on the gains of the receiving stage interference signals. The phase comparison unit 128 compares the phases of the receiving stage interference signals of the channels, and the microprocessor stores data on the phases of the receiving stage interference signals.

Thereafter, there is performed the step of calculating the interference signals in which data on the phases of the receiving stage interference signals of the channels are stored. When the MOD 1 mode of decreasing the errors of the main signals with maximum outputs is carried out in the vector value optimizer 132, a gain and phase correction is performed to set the gains and phases of the receiving stage interference signals to be the same as a reference channel (Channel No. 1) and data on the gains and phases are stored. When the MOD 2 mode of decreasing the errors of the main signals with maximum outputs is carried out in the vector value optimizer 132, the error rates of the main signals are calculated with soft data or expected error rates are applied, fine control is performed in a microprocessor, and vector values are designated.

Additionally, in the case of the application of interference signals, the synthesizing module 134 detects and stores transmission stage levels. At this time, if a level error occurs, a phase offset unit 108 is employed, a signal of 10 Hz is applied to the phase step unit 104 to detect a signal having 10 Hz. If it is determined that the interference cancellation has been completed by the waveform analysis of an interference cancellation state, the process is terminated and a service notice is transmitted, thus allowing the normal operation of the broadband wireless repeater to be carried out.

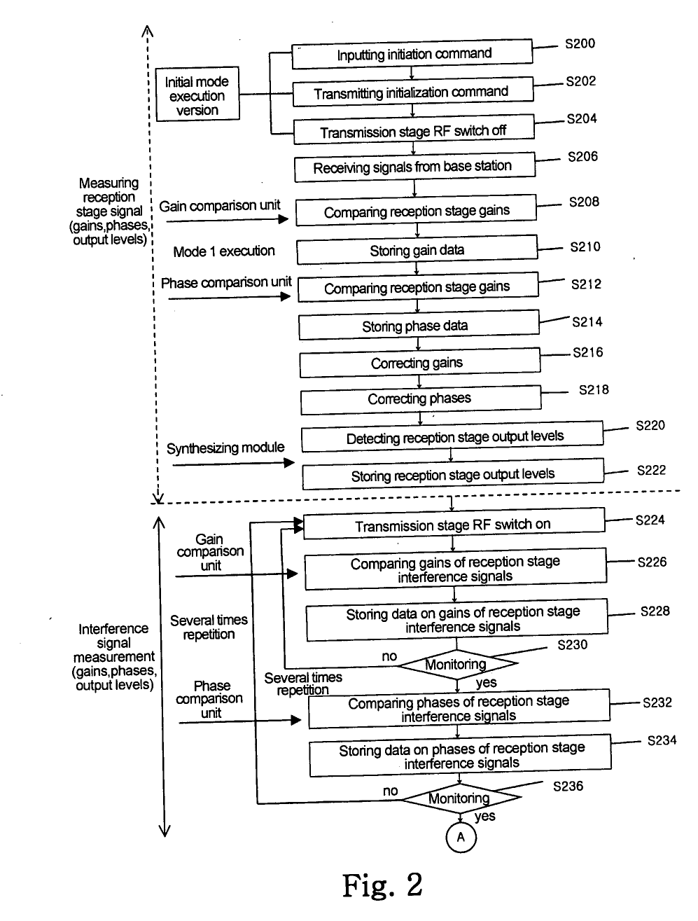

FIG. 2 is a flowchart showing an algorithm for measuring the receiving stage signals and interference signals of the broadband wireless repeater of the present invention.

In an initial mode execution version of the broadband wireless repeater, a command to initialize the broadband wireless repeater is inputted at step S200, the broadband wireless repeater initialization command is transmitted at step S202, the RF switch 100 of the transmission stage is turned off to block a path at step S204, and then a main signal is received from the base station at step S206.

Thereafter, the receiving stage gains of channels are compared in the gain comparison unit 130 at step S208, and then data on the receiving stage gains are stored in a microprocessor at step S210. Additionally, the receiving stage phases of the channels are compared in the phase comparison unit 128 at step S212, data on the receiving stage phases are stored in the microprocessor at step S214, the receiving stage gains of channels are corrected at step S216 and the receiving stage phases of the channels are corrected at step S218. Additionally, the output levels of the channels in a receiving stage bypass mode are detected by the synthesizing module 134 at step S220, and data on the output levels are stored in the microprocessor at step S222.

Subsequently, in order to measure interference signals, the transmission stage RF switch 100 is turned on to establish a path at step S224, and the gains of the receiving stage interference signals of the channels are compared in the gain comparison unit 130 at step S226, and then data on the gains of the receiving stage interference signals are stored in the microprocessor at step S228. The phases of the receiving stage interference signals of the channels are monitored and compared in the phase comparison unit 128 at steps S230 and S232, and data on the phases of the receiving stage interference signals are stored in the microprocessor at step S234 and monitored at step S236. At this time, the transmission stage RF switch 100 is turned off at step S238.

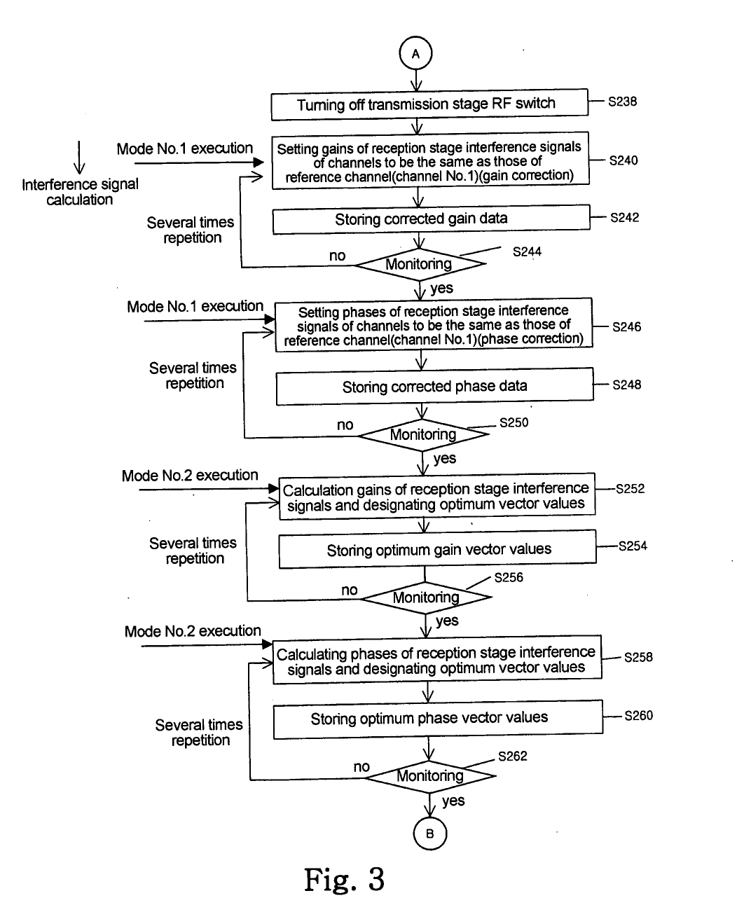

FIG. 3 is a flowchart showing an algorithm for calculating the interference signals of the broadband wireless repeater of the present invention.

When an interference signal mode No. 1 of the broadband wireless repeater of the broadband wireless repeater is executed, the vector value optimizer 132 corrects the gains of the receiving stage interference signals of the channels to be the same as those of a reference channel (Channel No.1) at step S240, the microprocessor stores data on the corrected gains of the interference signals at step S242, and the data on the corrected gains are monitored at step S244.

Subsequently, when the interference signal mode No. 1 is executed again, the phases of the receiving stage interference signals of the channels are corrected to be the same as those of the reference channel (Channel No.1) at step S246, the microprocessor stores data on the corrected phases at step S248, and the data on the corrected phases are monitored at step S250.

When an interference signal mode No. 2 is executed, the vector value optimizer 132 calculates the gains of the receiving stage interference signals of the channels and designates optimum vector values at step S252, the optimum gain vector values are stored in the microprocessor at step S254, and the stored data on the optimum gain vector values are monitored at step S256.

When an interference signal mode No. 2 is executed again, the vector value optimizer 132 calculates the phases of the receiving stage interference signals of the channels and designates optimum vector values at step S258, the optimum phase vector values are stored in the microprocessor at step S260, and the stored data on the optimum phase vector values are monitored at step S256.

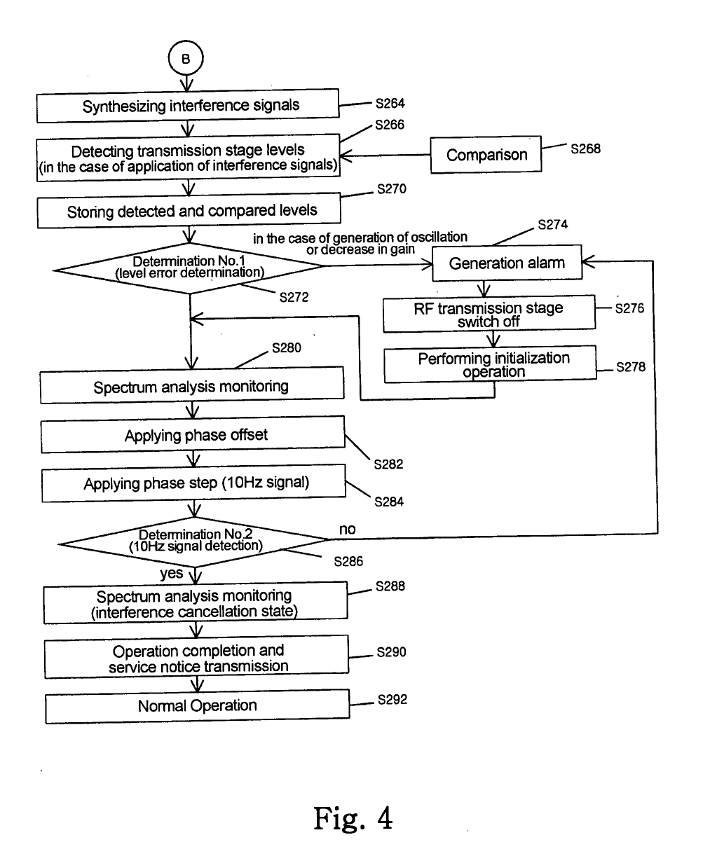

FIG. 4 is a flowchart showing an algorithm that is applied to the normal operation of the broadband wireless repeater of the present invention.

First, the receiving stage interference signals of the channels are synthesized in the synthesizing module 134 at step S264, transmission stage levels are detected in the case of the application of interference signals at step S266, transmission stage output level detection values and receiving stage output level values are compared in the case of a bypass mode at step S268, and compared detected output levels are stored in the microprocessor at step S270.

At this time, it is determined whether an output level error is present at step S272. If an oscillation is generated or a gain is decreased, an alarm is generated at step S274. When malfunction occurs, the transmission stage RF switch 100 is turned off to block a path at step S276 and an initialization step is performed at step S278.

Additionally, remote monitoring is carried out by a waveform analyzing module at step S280, and phase offset is applied to shift phases so as to form a phase difference between the main signal and the interference signal at step S282, and phase step (10 Hz signal) is applied at step S284.

Thereafter, detection and determination are carried out with 10 Hz signals at step S286. An interference cancellation state is monitored by a waveform analyzer at step S288. Subsequently, the process is terminated and a service notice is transmitted at step S290. Thereafter, a normal operation of the broadband wireless repeater is carried out at step S292.

The broadband wireless repeater for the mobile communication system in accordance with the present invention constructed as described above has the following effects.

First, the broadband wireless repeater can be added to an existing wireless repeating apparatus, so there can be reduced installation costs for steel towers that are needed to ensure the isolation of a transmitting antenna from a receiving antenna required in a wireless repeating apparatus.

Second, the broadband wireless repeater of the present invention can generate high output power, thus obtaining an even larger coverage area.

In a conventional wireless repeating apparatus, the sufficient isolation of a transmitting antenna from a receiving antenna is difficult to achieve, so the conventional wireless repeating apparatus cannot generate a desired output power, thus being incapable of obtaining a large coverage area. Accordingly, the broadband wireless repeating apparatus of the present invention can be employed instead of an optical repeater.

Additionally, the cost of optical lines can be reduced, and merits of an optical repeater can be maximized by positioning the broadband wireless repeater in a receiving stage of the optical repeater. Moreover, the broadband wireless repeater of the present invention is positioned on a rail on the top of a building in an apartment area or an urban area to be environmentally-friendly, and improves a communication quality in an area that has serious communication obstacles.

Third, the broadband wireless repeater of the present invention can carry out a broadband repeating service, so it can be applied to a present cellular network, a PCS network, a wireless local loop network, a future IMT-2000 network and a smart antenna network, thus reducing the number of base stations and, therefore, decreasing the cost of operation of such a network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A broadband wireless repeater for a mobile communication system, comprising:
a transmission stage comprised of,
a Radio Frequency (RF) switch for establishing a frequency path for wireless repeating signals at the same frequencies, an Intermediate Frequency (IF) delay unit for applying delay to IFs in the case of interference signal measurement, and bypassing the IF delay in the case where a service is being provided,
a frequency up conversion modulator for increasingly modulating frequencies of a transmission path,
an amplifier for amplifying transmission signals,
a filter unit for eliminating undesired band signals from the transmission signals, and
a transmitting side antenna for receiving signals outputted from the amplifier and transmitting the outputted signals to a shadow area or an urban area; and
a receiving stage comprised of,
an array antenna for receiving radio frequency signals from a base station and interference signals fed back from the transmitting antenna,
a band-pass filter unit for eliminating undesired band signals from the signals received by the array antenna,
an amplifier for amplifying only original signals of the RF signals received by the array antenna while suppressing noise components of the signals, thus improving sensitivity of the received signals,
a phase shifter for controlling phases of channels, a frequency down conversion modulator for decreasingly modulating frequencies of the received signals,
a phase comparison unit for controlling amplitudes of the channels and comparing the phases of the channels with each other,
a gain comparison unit for detecting, on the basis of a channel No. 1, phases of the modulated signals of the channels, and comparing gain differences with each other,
a vector value optimizer for selecting phase and amplitude values of one of the channels having a small error rate for its main signal by using the phase information of the phase comparison unit, or applying phases and amplitudes of other channels, thus decreasing errors of the main signals with a maximum output, and
a synthesizing module for detecting and storing output levels of the channels.

2. The broadband wireless repeater according to claim 1, wherein the vector value optimizer employs a MOD 1 manner of decreasing the errors of the main signals with maximum outputs, and includes a gain and phase correcting means for setting the gains and phases of the receiving stage interference signals to be the same as a reference channel (Channel No. 1).

3. The broadband wireless repeater according to claim 1, wherein the vector value optimizer can employ a MOD 2 manner of decreasing the errors of the main signals with maximum outputs, and includes a means for calculating error rates of the main signals with soft data or applying expected error rates and performing fine control in a microprocessor.

4. The broadband wireless repeater according to claim 1, further comprising, between an output end of the frequency up conversion modulator and an input end of the transmission stage amplifier,
a phase step unit for changing the phases of the signals at regular periods to divide the signals into interference signals and main signals so as to be applied in an initial test mode and monitor the signals at regular periods;
a phase monitor for monitoring the main signals and the interference signals and determining whether the interference signals have been cancelled in terms of analog signals and digital signals by using a spectrum analyzer, and transmitting results of the determination;
a phase offset unit for changing the phases of the signals to allow the vector value optimizer to produce optimum vector values; and
a gain control unit for compensating for gains changing depending upon error rates of the main signals in the vector value optimizer.
